(19) United States
(12) Patent Application Publication
(10) Pub. No.: US 2026/0326813 A1
(43) Pub. Date: Oct. 22, 2026

(54) SHAFT UNIT, METHOD FOR MANUFACTURING THEREOF, AND ELECTRIC ASSIST DEVICE

(71) Applicant: NSK STEERING & CONTROL, INC., Tokyo (JP)

(72) Inventors: Ryo OSAWA, Maebashi-shi (JP); Kentaro UNNO, Maebashi-shi (JP); Yuki KOZU, Maebashi-shi (JP); Toru ISHII, Maebashi-shi (JP)

(73) Assignee: NSK STEERING & CONTROL, INC., Tokyo (JP)

(21) Appl. No.: 19/109,641

(22) PCT Filed: Oct. 2, 2023
(86) PCT No.: PCT/JP2023/035926

§ 371 Date: Mar. 7, 2025

(30) Foreign Application Priority Data
Oct. 5, 2022 (JP) 2022-161215
Jul. 31, 2023 (JP) 2023-124154

(51) Int. Cl. B62D 5/04; F16H 55/22

(52) U.S. Cl. CPC B62D 5/0403; F16H 55/22

(57) ABSTRACT

A shaft unit includes a shaft member having a connecting shaft portion at an end portion on one side in an axial direction and a center hole opening on an end surface on the one side in an axial direction of the connecting shaft portion, and a joint member having a central hole penetrating in the axial direction on a radial inner side with the connecting shaft portion fitted into the central hole, the connecting shaft portion having a crimped portion formed by plastically deforming only a radial outer portion of an end edge portion on the one side in the axial direction, and the crimped portion brought into surface contact with an opening perimeter edge portion on the one side in the axial direction of the central hole of the joint member.

### TECHNICAL FIELD

The present disclosure relates to a shaft unit configured by connecting a shaft member and a joint member with a crimped portion, a manufacturing method thereof, and an electric assist device including the shaft unit.

### BACKGROUND ART

In the field of steering devices, electric power steering devices that are configured to apply auxiliary power to steering force transmission members such as a steering shaft, a pinion shaft, and a rack shaft in order to reduce the force required to operate a steering wheel are widely used. These electric power steering devices include an electric assist device for applying the auxiliary power.

The electric assist device includes an electric motor as a power source, a worm that is rotationally driven by the electric motor, and a worm wheel that meshes with the worm. In the electric assist device, a structure is also known in which a coupling is provided for connecting an output shaft of the electric motor and the worm so as to be capable of torque transmission while allowing misalignment such as mutual tilting or shaft misalignment (see U.S. Pat. No. 11,084,522).

The coupling includes a joint member connected to the output shaft of the electric motor and a joint member connected to an end portion on one side in the axial direction of the worm. These joint members are connected directly or through an intermediate joint member so as to be capable of torque transmission while allowing mutual misalignment.

U.S. Pat. No. 11,084,522 describes a specific structure of a shaft unit configured by connecting a shaft member configured as a worm and a joint member. In the shaft unit, the shaft member has a connecting shaft portion at an end portion on one side in the axial direction. The joint member has a central hole penetrating in the axial direction on the radial inner side, and the connecting shaft portion of the shaft member is fitted into the central hole. Furthermore, the shaft member has a center hole opening in a center portion in the radial direction of an end surface on the one side in the axial direction of the connecting shaft portion. That is, the end portion on the one side in the axial direction of the connecting shaft portion of the shaft member is configured to be cylindrical.

An outward flange-shaped crimped portion is formed at an end edge portion on the one side in the axial direction of the connecting shaft portion by plastically deforming the entire end edge portion in a radially outer direction. The shaft member and the joint member are connected by the crimped portion pressing an opening perimeter edge portion on the one side in the axial direction of the central hole of the joint member.

### CITATION LIST

### Patent Literature

Patent Literature 1: U.S. Pat. No. 11,084,522

### SUMMARY OF INVENTION

### Technical Problem

In the conventional shaft unit described above, when forming the crimped portion, the entire end edge portion on the one side in the axial direction of the connecting shaft portion is plastically deformed toward radially outside so as to deform the center hole of the connecting shaft portion.

The center hole is a portion that is used when machining an outer circumferential surface of a shaft member, measuring bending and rotational runout of the shaft member, and assembling the shaft member with other members. More specifically, a center shaft for centering and/or rotational support is engaged with the center hole. Therefore, if the center hole is deformed as a result of the formation of the crimped portion, there is a possibility that the center hole cannot be effectively used during measurements, assembly, or the like.

Such a problem is not limited to shaft units configured with a worm and a joint member configuring an electric assist device, but occur similarly in shaft units that configure various types of mechanical devices.

An object according to the present disclosure is to achieve a shaft unit capable of suppressing deformation of a center hole that occurs due to the formation of a crimpled portion, a manufacturing method thereof, and an electric assist device including the shaft unit.

### Solution to Problem

A shaft unit according to an aspect of the present disclosure includes a shaft member having a connecting shaft portion at an end portion on one side in an axial direction and a center hole opening in a center portion in a radial direction of an end surface on the one side in the axial direction of the connecting shaft portion, and a joint member having a central hole penetrating in the axial direction on a radial inner side with the connecting shaft portion fitted into the central hole. The joint member is a member for connecting the shaft member and a mating shaft member adjacent to the shaft member so as to be capable of torque transmission.

In the shaft unit according to an aspect of the present disclosure, the connecting shaft portion has a crimped portion formed by plastically deforming only a radial outer portion of an end edge portion on the one side in the axial direction protruding from the central hole, and the crimped portion is brought into surface contact with an opening perimeter edge portion on the one side in the axial direction of the central hole of the joint member.

In the shaft unit according to an aspect of the present disclosure, at least a radial outer portion of a side surface on the one side in the axial direction of the crimped portion is configured with an inclined surface portion that is inclined in a direction toward the other side in the axial direction as going toward a radial outer side.

In the shaft unit according to an aspect of the present disclosure, the opening perimeter edge portion of the joint member is configured with a chamfered portion that is inclined in a direction toward the radial outer side as going toward the one side in the axial direction.

In the shaft unit according to an aspect of the present disclosure, the shaft member is configured as a worm.

An electric assist device according to an aspect of the present disclosure includes a worm wheel, a worm engaged with the worm wheel, a coupling including a joint member connected to a connecting shaft portion provided at an end portion on one side in an axial direction of the worm, and an electric motor that transmits torque to the worm through the coupling. A shaft unit including the worm and the joint member is configured with the shaft unit according to an aspect of the present disclosure.

In a method for manufacturing a shaft unit according to an aspect of the present disclosure, the shaft unit to be manufactured includes a shaft member having a connecting shaft portion at an end portion on one side in an axial direction and a center hole opening to a center portion in a radial direction of an end surface on the one side in the axial direction of the connecting shaft portion, and a joint member having a central hole penetrating in the axial direction on a radial inner side.

The method for manufacturing the shaft unit according to an aspect of the present disclosure includes a step of pressing a radial outer portion of an end edge portion on the one side in the axial direction of the connecting shaft portion protruding from the central hole in a state where the connecting shaft portion is fitted into the central hole of the joint member so as to compress the radial outer portion in the axial direction to form a crimped portion, and bringing the crimped portion into surface contact with an opening perimeter edge portion on the one side in the axial direction of the central hole of the joint member.

The method for manufacturing the shaft unit according to an aspect of the present disclosure includes a step of press-fitting the joint member onto an outer circumferential surface of the connecting shaft portion from the one side in the axial direction, wherein
in the shaft unit,
an inner circumferential surface of the central hole is configured with a serration portion,
an outer diameter of an entire portion of the connecting shaft portion that protrudes from the central hole of the joint member to the one side in the axial direction is less than or equal to an inner diameter of the serration portion, and
in the step of press-fitting the joint member, teeth of the serration portion are engaged into the outer circumferential surface of the connecting shaft portion, and by completing the press-fitting of the joint member, the connecting shaft portion is fitted into the central hole of the joint member.

In the method for manufacturing the shaft unit according to an aspect of the present disclosure, in the process of forming the crimped portion, a radial outer portion of the pressing surface presses a side surface on the one side in the axial direction of the crimped portion toward the other side in the axial direction and toward a radial inner side.

In the method for manufacturing the shaft unit according to an aspect of the present disclosure, the shaft member is configured as a worm.

The present disclosure may be implemented by appropriately combining the structure of each aspect described above as long as no contradiction occurs.

### Effect of Invention

With the present disclosure, it is possible to provide a shaft unit that is capable of suppressing deformation of a center hole that occurs due to the formation of a crimpled portion, a manufacturing method thereof, and an electric assist device including the shaft unit.

### BRIEF DESCRIPTION OF DRAWINGS

FIG. 1 is a side view in partial cross section of an electric power steering device to which an electric assist device of a first example of an embodiment of the present disclosure is applied.

FIG. 2 is a cross-sectional view of section A-A in FIG. 1, illustrating the electric assist device of the first example.

FIG. 3 is an enlarged view of section B in FIG. 2, illustrating a connecting portion between a worm and an output shaft of an electric motor in the electric assist device of the first example.

FIG. 4 is an exploded perspective view of a coupling including a worm, a worm-side joint member, an intermediate joint member, and a motor-side joint member in the connecting portion of the electric assist device of the first example. A shaft unit of the first example includes a shaft member configured as a worm and a worm-side joint member.

FIG. 5 is a perspective view illustrating an end portion on one side in an axial direction of the shaft unit of the first example.

FIG. 6 is a cross-sectional view illustrating the end portion on the one side in the axial direction of the shaft unit of the first example.

FIG. 7 is an enlarged view of section C in FIG. 6.

FIG. 8 is a view illustrating the end portion on the one side in the axial direction of the shaft member before the worm-side joint member is press-fitted onto an outer circumferential surface of a connecting shaft portion of the shaft member in the first example.

FIG. 9 is a partial cross-sectional view illustrating a stage immediately before the worm-side joint member is press-fitted onto the outer circumferential surface of the connecting shaft portion in a process of manufacturing the shaft unit of the first example.

FIG. 10 is a partial cross-sectional view illustrating a stage in which the worm-side joint member is press-fitted onto the outer circumferential surface of the connecting shaft portion in the process of manufacturing the shaft unit of the first example.

FIG. 11 is a cross-sectional view of a pressing punch used in a method for manufacturing the shaft unit of the first example.

FIG. 12 is an enlarged view of section D in FIG. 11.

FIG. 13 is a partial cross-sectional view illustrating a stage immediately before forming a crimped portion in the process of manufacturing the shaft unit of the first example.

FIG. 14 is a partial cross-sectional view illustrating an initiation stage of forming the crimped portion in the process of manufacturing the shaft unit of the first example.

FIG. 15 is an enlarged view of section E in FIG. 14.

FIG. 16 is a partial cross-sectional view illustrating a completion stage of forming the crimped portion in the process of manufacturing the shaft unit of the first example.

FIG. 17 is an enlarged view of section F in FIG. 16.

FIG. 18 is a cross-sectional view of a half portion of a portion on the one side in the axial direction of a shaft member (worm) configuring a shaft unit of a second example of an embodiment of the present disclosure.

FIG. 19A is a partial cross-sectional view illustrating a stage in which a worm-side joint member is press-fitted onto an outer circumferential surface of a connecting shaft portion of the shaft member in a process of manufacturing the shaft unit of the second example, and FIG. 19B is a partial cross-sectional view illustrating a completion stage of forming a crimped portion.

### DESCRIPTION OF EMBODIMENTS

The present disclosure is applicable to various shaft units that are incorporated into parts of various types of mechanical devices and are configured by a shaft member and a joint member. Examples of the shaft member include torque transmission shafts such as worms, sliding screw shafts, ball screw shafts, motor shafts, steering shafts, and rack shafts, and pinion shafts. The joint member is a member for connecting the shaft member and a mating shaft member adjacent to the shaft member so as to be capable of torque transmission. Examples of the joint member include joint members configuring various joint devices such as couplings, universal joints, and constant velocity joints.

### First Example

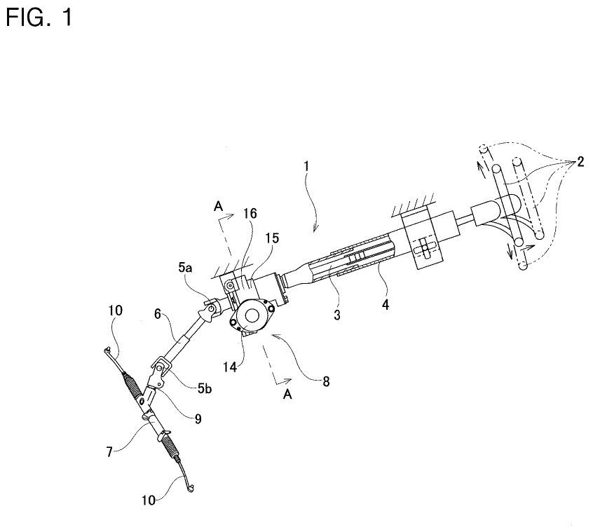

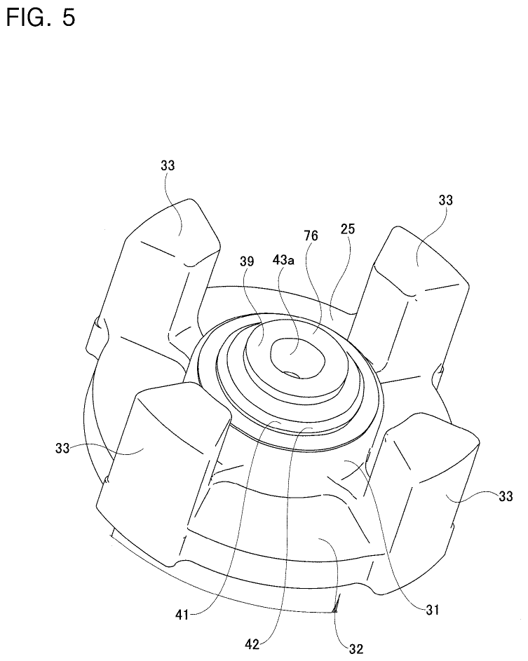

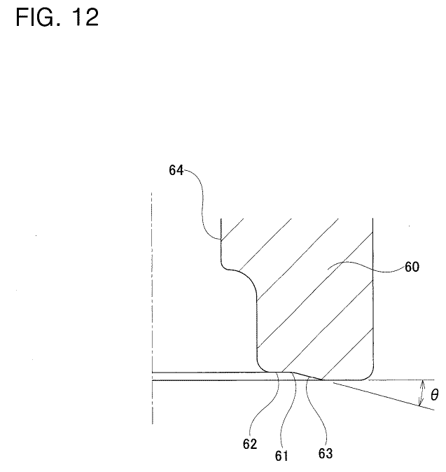

A first example of an embodiment of the present disclosure will be described with reference to FIG. 1 to FIG. 17. In the first example, the present disclosure is applied to a shaft unit configured with a worm and a joint member thereof, which is incorporated in an electric assist device of an electric power steering device.

### (1) Shaft Unit

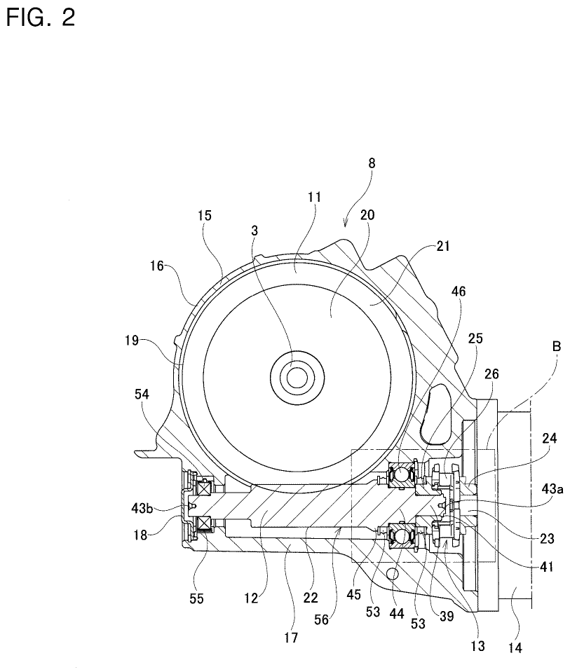

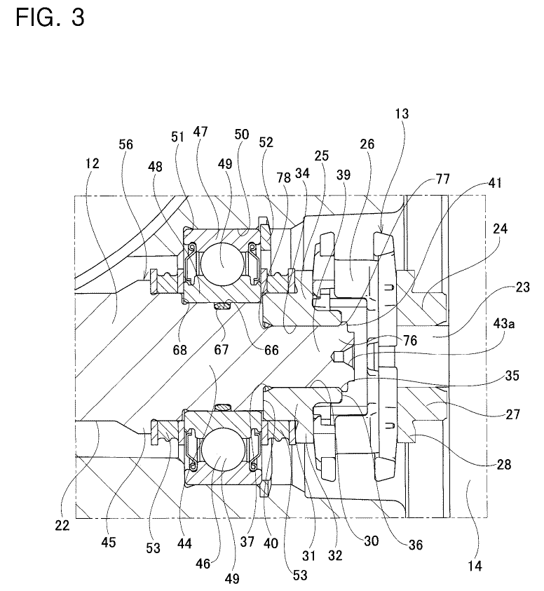

A shaft unit 56 of the first example is particularly illustrated in FIG. 1 to FIG. 7. As illustrated in FIG. 2 and FIG. 3, the shaft unit 56 of the present example has a shaft member 12 having a connecting shaft portion 39 at an end portion on one side in the axial direction and a center hole 43a opening in a center portion in the radial direction of an end surface on the one side in the axial direction of the connecting shaft portion 39, and a joint member 25 having a central hole 30 penetrating in the axial direction on the radial inner side, with the connecting shaft portion 39 fitted into the central hole 30. The connecting shaft portion 39 has a crimped portion 41 formed by plastically deforming only a radial outer portion of an end edge portion on the one side in an axial direction protruding from the central hole 30, and the crimped portion 41 is brought into surface contact with an opening perimeter edge portion 77 on the one side in the axial direction of the central hole 30 of the joint member 25.

Regarding the shaft unit 56, the one side in the axial direction is the right side in FIG. 2 and FIG. 3, and the other side in the axial direction is the left side in FIG. 2 and FIG. 3.

In the present example, the shaft member 12 is configured as a worm. The joint member 25 is configured as a worm-side joint member, which is a part of a coupling 13.

The shaft member (worm) 12 of the present example is made of metal, and has worm teeth 22 on an outer circumferential surface of in a middle portion in the axial direction. The material and shape of the shaft member 12 are arbitrarily determined depending on the type and application of the shaft unit to which the present disclosure is applied. In the shaft member 12 of the present example, the connecting shaft portion 39 provided at the end portion on the one side in the axial direction has an outer diameter smaller than a portion adjacent to the other side in the axial direction. That is, the shaft member 12 of the present example includes, in a portion between the connecting shaft portion 39 and the worm teeth 22, in order from the one side in the axial direction, a fitting shaft portion 44 having a diameter larger than the connecting shaft portion 39, and a flange portion 45 protruding radially outward. The outer circumferential surface of the connecting shaft portion 39 and the outer circumferential surface of the fitting shaft portion 44 are connected by a stepped surface 40 facing the one side in the axial direction.

In the present example, the center hole 43a that opens in the center portion in the radial direction of the end surface on the one side in an axial direction of the connecting shaft portion 39 is located at the end portion on the one side in the axial direction of the connecting shaft portion 39 and is arranged so as to overlap with the crimped portion 41 in the radial direction. A portion around the center hole 43a at the end portion on the one side in the axial direction of the connecting shaft portion 39 is configured with a cylindrical portion 76. The center hole 43a is a portion that is used when machining the outer circumferential surface of the shaft member 12, measuring bending and rotational runout of the shaft member 12, and assembling the shaft member 12 with other members. More specifically, a center shaft for centering and/or rotational support is engaged with the center hole 43a.

The shaft member 12 of the present example is also provided with a center hole 43b at an end portion on the other side in the axial direction, the center hole 43b opening in the center portion in the radial direction of an end surface on the other side in the axial direction.

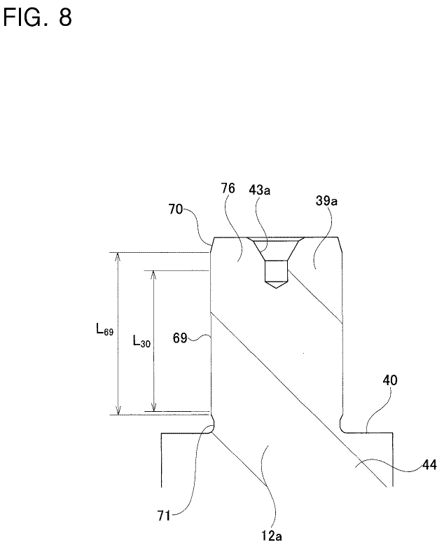

In the present example, a portion of the outer circumferential surface of the connecting shaft portion 39 that is fitted into the central hole 30 of the joint member (worm-side joint member) 25 is configured with a cylindrical surface. In the present example, as illustrated in FIG. 8 and other figures, a relief groove 71 is provided over the entire circumference at the end portion on the other side in the axial direction of the outer circumferential surface of the connecting shaft portion 39, which is located further on the other side in the axial direction than a portion that is fitted into the central hole 30 of the joint member 25. The relief groove 71 is a portion for allowing a blade of a cutting tool to escape when manufacturing the worm 12. In a case of implementing the present disclosure, the relief groove 71 can be omitted if not necessary.

The joint member 25 of the present example is made of metal. The material and shape of the joint member 25 are arbitrarily determined depending on the type and application of the shaft unit to which the present disclosure is applied. The central hole 30 of the joint member 25 is provided on the radial inner side of a tubular portion 31, which configurs a radial inner portion of the joint member 25. In the present example, the inner circumferential surface of the central hole 30 is configured with a serration portion 34.

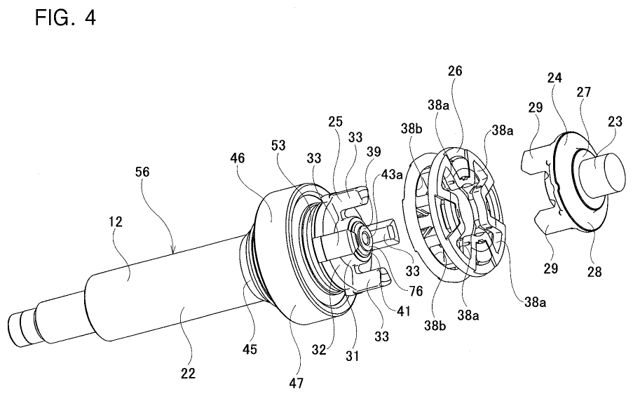

As illustrated in FIG. 4 to FIG. 6, the joint member 25 of the present example includes an annular flange portion 32 that protrudes on the radial outer side from a middle portion in the axial direction of the tubular portion 31, and tooth portions 33 that protrude toward the one side in the axial direction from plural locations (four locations in the present example) so as to be uniformly spaced in the circumferential direction of a radial outer portion of the flange portion 32. The thickness in the radial direction of the tubular portion 31 is greater at a portion located on the other side in the axial direction of the flange portion 32 than at a portion located on the one side in the axial direction of the flange portion 32.

In the present example, the joint member 25 is formed by subjecting a metal material to necessary processes such as forging, cutting, or the like and then the entire joint member 25 is subjected to heat treatment so that it is harder than the worm 12. That is, the serration portion 34 has a greater hardness than the outer circumferential surface of the connecting shaft portion 39.

The joint member 25 is press-fitted onto the outer circumferential surface of the connecting shaft portion 39 from the one side in the axial direction, and the end surface on the other side in the axial direction of the tubular portion 31 of the joint member 25 abuts against the stepped surface 40. In the present example, as a result of the press-fitting of the joint member 25, the teeth of the serration portion 34 (the tip portion of the teeth portion 33) are engaged into the outer circumferential surface of the connecting shaft portion 39.

In the present example, a large diameter portion 37 having an inner diameter larger than the inner circumferential surface of the central hole 30 is provided at an opening perimeter edge portion 78 on the other side in the axial direction of the central hole 30 of the joint member 25. The large diameter portion 37 is a portion that forms a space between the outer circumferential surface of the connecting shaft portion 39 and the large diameter portion 37 for collecting shavings generated during the press-fitting. Further, the large diameter portion 37 is configured with a conical surface such as a C-chamfered portion that is inclined in a direction toward the radial outer side as going toward the other side in the axial direction. However, in a case of implementing the present disclosure, the large diameter portion 37 may also be configured with a curved surface such as a R-chamfered portion, or a cylindrical surface having a diameter larger than the inner circumferential surface of the central hole.

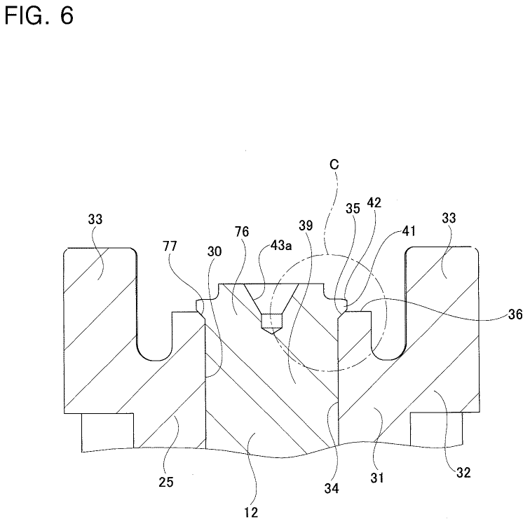

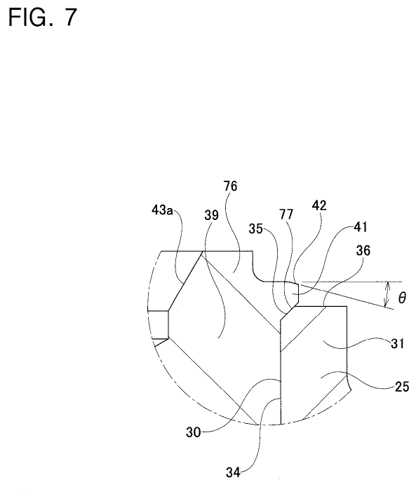

In the present example, as illustrated in FIG. 6 and FIG. 7, the opening perimeter edge portion 77 on the one side in the axial direction of the central hole 30 of the joint member 25 is configured with a chamfered portion 35 that is inclined in a direction toward the radial outer side as going toward the one side in the axial direction. That is, the inner circumferential surface of the central hole 30 and the end surface 36 on the one side in the axial direction of the tubular portion 31 are connected through the chamfered portion 35. In the present example, the chamfered portion 35 is configured with a linearly inclined C-chamfered portion. However, in a case of implementing the present disclosure, the chamfered portion 35 configuring the opening perimeter edge portion 77 of the joint member 25 may be configured with a curvedly inclined R-chamfered portion, or a chamfered portion whose inclination angle increases stepwise toward the one side in the axial direction.

In the present example, the outer diameter of the chamfered portion 35, in other words, the inner diameter of the end surface 36 on the one side in the axial direction of the tubular portion 31, is larger than the groove bottom diameter of the serration portion 34. Therefore, the end portion on the one side in the axial direction of the grooves of the serration portion 34 opens only to the chamfered portion 35 and does not open to the end surface 36 on the one side in the axial direction of the tubular portion 31.

The engagement relationship between the shaft member 12 and the joint member 25 is arbitrarily determined depending on the type and application of the shaft unit to which the present disclosure is applied. For example, when the present disclosure is applied to a shaft unit configured with a worm and a joint member thereof, an inner circumferential surface of a central hole of the joint member may be configured with a cylindrical surface, a portion of an outer circumferential surface of a connecting shaft portion that is fitted into the central hole of a worm-side joint member may be configured with a serration portion, and the hardness of the worm-side joint member may be made lower than that of the connecting shaft portion.

In addition, as for the engagement relationship between the shaft member and the joint member, if it is possible to effectively prevent relative rotation between the shaft member and the joint member according to the material, type, and application of the shaft unit, it is also possible to apply press-fitting, knurled fitting, key engagement, spline engagement, serration engagement, or the like between cylindrical surfaces.

In the present example, as illustrated in FIG. 6 and FIG. 7, the crimped portion 41 formed by plastically deforming only the radial outer portion of an end edge portion on the one side in the axial direction of the connecting shaft portion 39 is brought into surface contact with the chamfered portion 35 over the entire circumference. That is, the crimped portion 41 protrudes on the radial outer side from a portion of the outer circumferential surface of the connecting shaft portion 39 that is adjacent to the other side in the axial direction of the crimped portion 41. A side surface on the other side in the axial direction of the crimped portion 41 is configured with an annular surface that is inclined in a direction toward the one side in the axial direction as going toward the radial outer side, matching the chamfered portion 35, and is brought into surface contact with the chamfered portion 35 over the entire circumference. In the present example, the side surface on the other side in the axial direction of the crimped portion 41 is brought into surface contact with the chamfered portion 35 over the entire circumference without any gaps.

In the present example, the opening portion on the one side in the axial direction of the grooves of the serration portion 34 is entirely blocked by the crimped portion 41.

In the present example, the joint member 25 is externally fitted and fixed to the connecting shaft portion 39 while being held from both sides in the axial direction by the stepped surface 40 and the crimped portion 41 of the shaft member 12, and is prevented from falling off from the connecting shaft portion 39 to the one side in the axial direction by the crimped portion 41.

In particular, in the present example, since the crimped portion 41 is brought into surface contact with the opening perimeter edge portion 77 (chamfered portion 35) of the joint member 25 over the entire circumference, the crimped portion 41 can firmly hold the joint member 25 from the one side in the axial direction, compared to the configuration of a comparative example in which the crimped portion is only in line contact with the opening perimeter edge portion (corner portion) of the central hole over the entire circumference. As a result, the crimped portion 41 can effectively prevent the joint member 25 from falling off from the connecting shaft portion 39 toward the one side in the axial direction.

In the present example, the joint member 25 and the shaft member 12 can be effectively prevented from rotating relative to each other by utilizing not only an engagement force that acts on a fitting portion between the serration portion 34 of the joint member 25 and the outer circumferential surface of the connecting shaft portion 39 of the shaft member 12 and a friction force that acts on an abutment portion between the end surface on the other side in the axial direction of the tubular portion 31 of the joint member 25 and the stepped surface 40 of the shaft member 12, but also a large friction force that acts on a surface contact portion between the opening perimeter edge portion 77 of the joint member 25 and the crimped portion 41 of the shaft member 12.

In particular, in the configuration of the present example, compared to the comparative example in which the crimped portion comes in line contact, the contact area between the crimped portion 41 and the opening perimeter edge portion 77 (chamfered portion 35) can be made larger. As a result, a frictional force that acts on the contact portion can be largely ensured, and relative rotation between the shaft member 12 and the joint member 25 can be effectively prevented.

In a case of implementing the present disclosure, the chamfered portion 35 of the opening perimeter edge portion 77 of the joint member 25 may be omitted. In this case, the opening perimeter edge portion with which the crimped portion 41 comes into surface contact is a radial inner end portion of the end surface on the one side in the axial direction of the joint member 25.

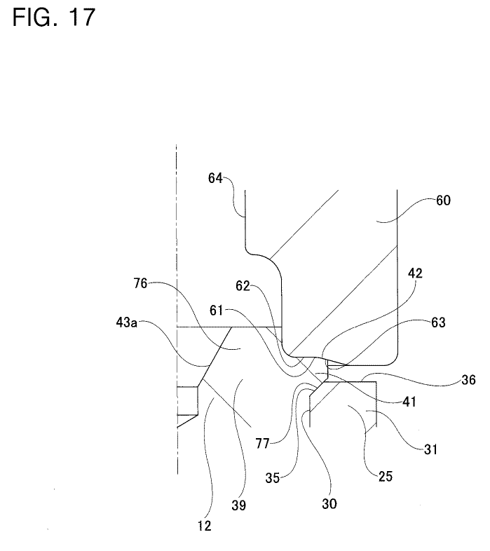

In the present example, as illustrated in FIG. 6 and FIG. 7, at least the radial outer portion of the side surface on the one side in the axial direction of the crimped portion 41 is configured with an inclined surface portion 42 that is inclined toward the other side in the axial direction as going to the radial outer side. In the present example, only the radial outer portion of the side surface on the one side in the axial direction of the crimped portion 41 is configured with the inclined surface portion 42. However, in a case of implementing the present disclosure, the entire side surface on the one side in the axial direction of the crimped portion 41 may be configured with the inclined surface portion 42. The inclined surface portion 42 is a plastically processed surface formed by being pressed by a pressing punch 60 (see FIG. 17) for forming the crimped portion 41.

That is, in the present example, when forming the crimped portion 41, at least the radial outer portion of the side surface on the one side in the axial direction of the crimped portion 41, where the inclined surface portion 42 is formed, is pressed toward the other side in the axial direction and toward the radial inner side by the pressing punch 60, thereby applying a compressive stress to the crimped portion 41. Therefore, cracks are less likely to occur in the crimped portion 41 compared to a case where the crimped portion is formed by pressing the entire side surface on the one side in the axial direction of the crimped portion by the pressing punch only toward the other side in the axial direction, or a case where the crimped portion is formed by expanding the entire end edge portion on the one side in the axial direction of the connecting shaft portion to the radial outer side.

In the present example, the generatrix shape (cross-sectional shape) of the inclined surface portion 42 is a straight line. The inclination angle θ of the inclined surface portion 42 with respect to an imaginary flat plane perpendicular to the axial direction of the worm 12 can be set arbitrarily within a range greater than 0 degrees, however, from a view point of ensuring an effect of suppressing a crack from occurring in the crimped portion 41, the inclination angle θ is preferably set to 15 degrees or more, and from a view point of suppressing the processing force for forming the crimped portion 41, the inclination angle θ is preferably set to 45 degrees or less.

In a case of implementing the present disclosure, the generatrix shape (cross-sectional shape) of the inclined surface portion 42 configuring the side surface on the one side in the axial direction of the crimped portion 41 may also be formed into a curved shape.

In a case of implementing the present disclosure, the side surface on the one side in the axial direction of the crimped portion 41 may also be configured with a flat surface perpendicular to the axial direction of the shaft member 12.

### (2) Method for Manufacturing Shaft Unit

A method for manufacturing the shaft unit 56 of the first example is particularly illustrated in FIG. 8 to FIG. 17. The method for manufacturing the shaft unit 56 of the present example is characterized in that it includes a step of pressing the radial outer portion of the end edge portion on the one side in an axial direction of the connecting shaft portion 39 protruding from the central hole 30 in a state where the connecting shaft portion 39 is fitted into the central hole 30 of the joint member 25 by the pressing surface 61 of the pressing punch 60 so as to compress the radial outer portion toward the other side in the axial direction to form the crimped portion 41, and bringing the crimped portion 41 into surface contact with the opening perimeter edge portion 77 on the one side in the axial direction of the central hole 30 of the joint member 25.

When manufacturing the shaft unit 56, as optional preparatory steps, a step of obtaining an intermediate shaft member 12a and the joint member 25, and a step of press-fitting the joint member 25 onto the outer circumferential surface of the connecting shaft portion 39a of the intermediate shaft member 12a from the one side in the axial direction, may be provided.

First, depending on the material and shape of the shaft member 12, an intermediate shaft member 12a is obtained by any material and processing means, prior to press-fitting the connecting shaft portion 39a into the central hole 30 of the joint member 25. In the present example, the intermediate shaft member 12a is obtained by subjecting a metal material to necessary processes such as forging and cutting.

The intermediate shaft member 12a differs from the completed shaft member 12 only in the shape of the outer circumferential surface of the connecting shaft portion 39a. More specifically, the crimped portion 41 is not formed at the end portion on the one side in the axial direction of the outer circumferential surface of the connecting shaft portion 39a. In the present example, as illustrated in FIG. 8, the outer circumferential surface of the connecting shaft portion 39a has a cylindrical surface portion 69 in a middle portion in the axial direction, and a guide surface portion 70 at an end portion on the one side in the axial direction adjacent to the one side in the axial direction of the cylindrical surface portion 69, and a relief groove 71 over the entire circumference at an end portion on the other side in the axial direction adjacent to the other side in the axial direction of the cylindrical surface portion 69.

The cylindrical surface portion 69 is configured with a cylindrical surface whose outer diameter does not change in the axial direction. In the present example, on the outer circumferential surface of the connecting shaft portion 39a, the axial range L₆₉ of the cylindrical surface portion 69 includes the axial range L₃₀ of a portion that is fitted into the central hole 30 of the joint member 25 after the shaft unit 56 is completed (L₆₉⊂L₃₀).

The outer diameter of the cylindrical surface portion 69 is larger than the inner diameter of the serration portion 34 of the joint member 25. More specifically, the outer diameter of the cylindrical surface portion 69 is larger than the tip diameter of the serration portion 34 and smaller than the root diameter of the serration portion 34.

The guide surface portion 70 is configured with a conical surface whose outer diameter decreases toward the one side in the axial direction. The guide surface portion 70 is a portion that functions as a guide when the joint member 25 begins to be press-fitted onto the outer circumferential surface of the connecting shaft portion 39a from the one side in the axial direction. In a case of implementing the present disclosure, the guide surface portion 70 may be omitted.

Depending on the material and shape of the joint member 25, the joint member 25 is obtained by any material and processing means. In the present example, the joint member 25 is obtained by subjecting a metal material to necessary processes such as forging and cutting, and heat treatment. Alternatively, if required mechanical properties such as hardness can be ensured, the joint member 25 can be obtained by sintering metal powder.

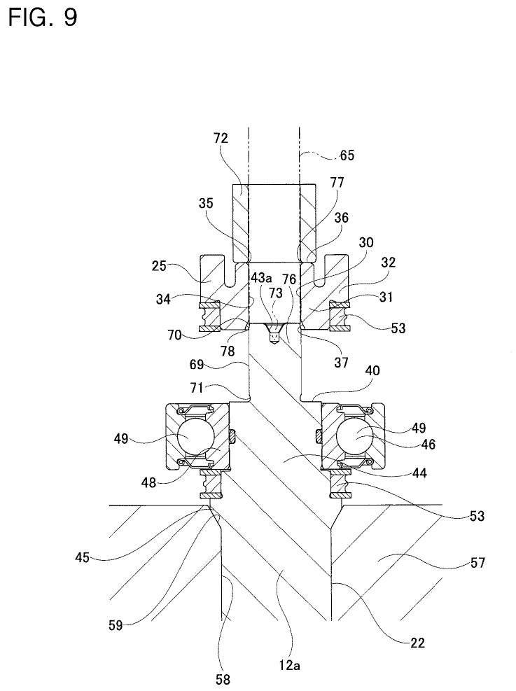

Next, the joint member 25 is press-fitted onto the outer circumferential surface of the connecting shaft portion 39a of the intermediate shaft member 12a from the one side in the axial direction. In the process of press-fitting the joint member 25, first, as illustrated in FIG. 9, the intermediate shaft member 12a is supported by a support base 57 with the end portion on the one side in the axial direction facing upward. More specifically, the outer circumferential surface of the intermediate shaft member 12a is fitted into a support hole 58 provided in the support base, and the side surface on the other side in the axial direction of the flange portion 45 provided on the intermediate shaft member 12a is supported by a support surface 59 of the support base 57, thereby preventing the intermediate shaft member 12a from being displaced in the radial direction and to the other side in the axial direction.

In the present example, the worm teeth 22 of the intermediate shaft member 12a are fitted into the support hole 58 of the support base 57, and the conical convex side surface of the flange portion 45 of the intermediate shaft member 12a is supported by a conical concave support surface 59 provided on an opening perimeter edge portion on the one side in the axial direction of the support hole 58 of the support base 57.

Then, using a cylindrical press-fitting jig 72, the joint member 25 is press-fitted onto the outer circumferential surface of the connecting shaft portion 39a of the intermediate shaft member 12a from the one side in the axial direction.

In the present example, the press-fitting of the joint member 25 is implemented with a ball bearing 46 and a worm damper 53 on the other side in the axial direction arranged around a portion on the one side in the axial direction of the intermediate shaft member 12a, which is located above the support base 57, and with a worm damper 53 on the one side in the axial direction arranged around an end portion on the other side in the axial direction of the tubular portion 31 of the joint member 25.

More specifically, first, as illustrated in FIG. 9, a columnar center shaft 65 is inserted with no looseness in the radial direction into the joint member 25 provides with the worm damper 53 on the one side in the axial direction around the end portion on the other side in the axial direction of the tubular portion 31, and the press-fitting jig 72 arranged adjacent to and above the joint member 25, and then a conical engaging portion 73 provided in the center portion in the radial direction of a lower end portion of the center shaft 65 is engaged with the center hole 43a on the one side in the axial direction of the intermediate shaft member 12a.

As a result, the worm damper 53 on the one side in the axial direction, the joint member 25, and the press-fitting jig 72 are arranged above the intermediate shaft member 12a and coaxially with the intermediate shaft member 12a.

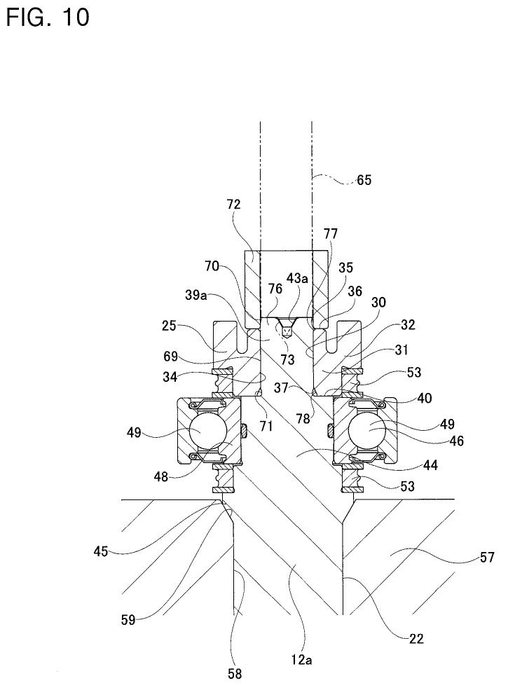

Next, as illustrated in FIG. 9 to FIG. 10, by pressing the end surface 36 on the one side in the axial direction of the tubular portion 31 of the joint member 25 with the press-fitting jig 72, the joint member 25 is press-fitted onto the outer circumferential surface of the connecting shaft portion 39a from the one side in the axial direction, and the end surface on the other side in the axial direction of the tubular portion 31 of the joint member 25 is abutted against the stepped surface 40 of the intermediate shaft member 12a. In the present example, as a result of this press-fitting, the teeth of the serration portion 34 of the worm-side joint member 25 (the tip portion of the teeth portion 33) are engaged into the cylindrical surface portion 69 provided at the middle portion in the axial direction of the outer circumferential surface of the connecting shaft portion 39a.

In the present example, if shavings are generated on the outer circumferential surface of the connecting shaft portion 39a due to this press-fitting, the shavings are collected in the space between the outer circumferential surface of the connecting shaft portion 39a and the large diameter portion 37 of the joint member 25.

In the present example, as illustrated in FIG. 10, in a state where the joint member 25 is press-fitted onto the outer circumferential surface of the connecting shaft portion 39a from the one side in the axial direction, the end portion on the one side in the axial direction of the connecting shaft portion 39a (including the end portion on the one side in the axial direction of the cylindrical surface portion 69) protrudes from the central hole 30 of the joint member 25 to the one side in the axial direction.

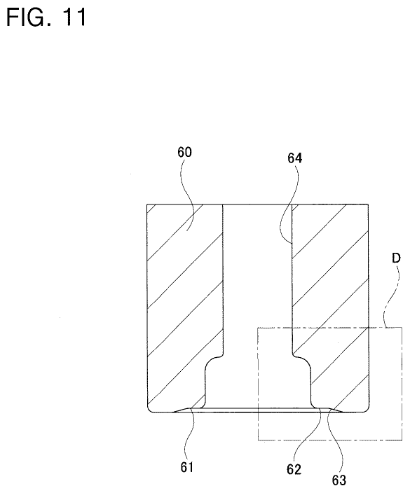

Next, by completing the step of press-fitting the joint member 25, the connecting shaft portion 39 is fitted into the central hole 30 of the joint member 25, and then a step of forming the crimped portion 41 is performed using a pressing punch 60 as illustrated in FIG. 11 to FIG. 13. The pressing punch 60 is configured to be cylindrical as a whole, and has a pressing surface 61 on the radial inner side of the lower end surface in the axial direction.

In the present example, the radial inner portion of the pressing surface 61 is configured with a flat surface portion 62 perpendicular to the axial direction of the pressing punch 60, and the radial outer portion of the pressing surface 61 is configured with an inclined surface portion 63 inclined downward as going toward the radial outer side. The radial outer end portion of the flat surface portion 62 and the radial inner end portion of the inclined surface portion 63 are smoothly connected. The central hole of the pressing punch 60 has a guide hole portion 64 in a section from a middle portion in the axial direction to an upper end portion in the axial direction, the guide hole portion 64 having a smaller diameter than that of a lower end portion in the axial direction.

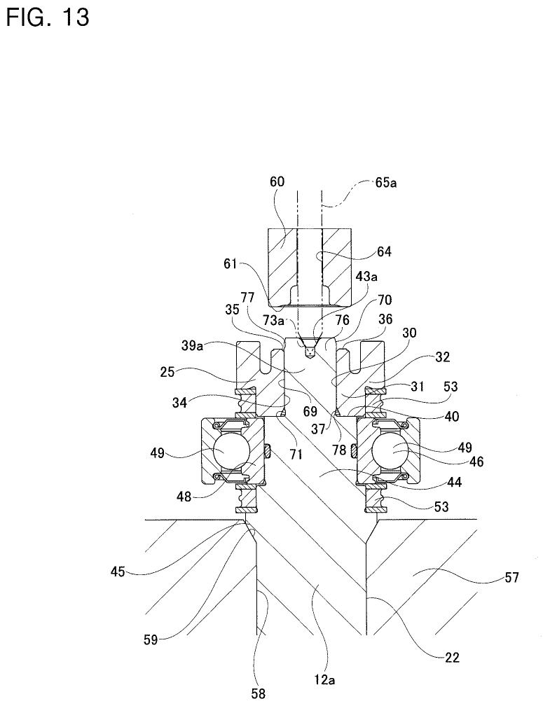

In the process of forming the crimped portion 41 using the pressing punch 60, first, as illustrated in FIG. 13, the conical engaging portion 73a provided at the lower end portion of the center shaft 65a, which is inserted into the guide hole portion 64 of the pressing punch 60 with no looseness in the radial direction, is engaged with the center hole 43a on the one side in the axial direction of the intermediate shaft member 12a. As a result, the pressing punch 60 is arranged above the intermediate shaft member 12a and coaxially with the intermediate shaft member 12a.

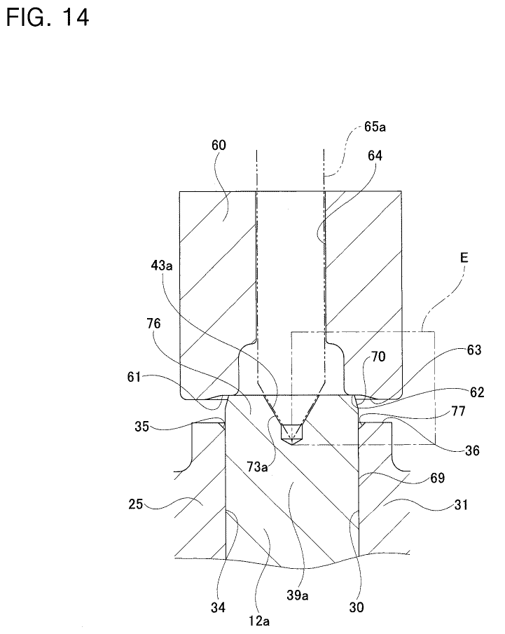

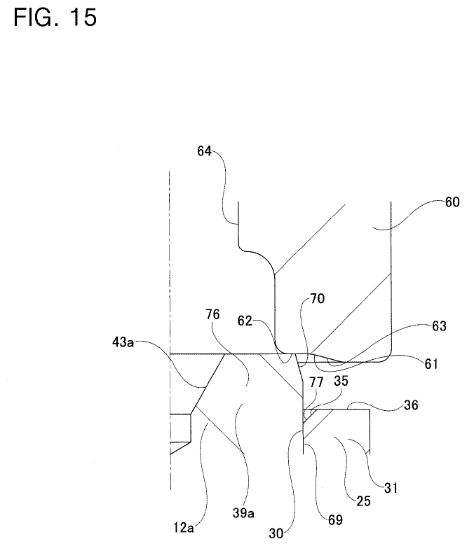

Next, the pressing punch 60 is moved downward along the center shaft 65a from the state illustrated in FIG. 13 to the state illustrated in FIG. 14 and FIG. 15, and the flat surface portion 62 of the pressing surface 61 of the pressing punch 60 is abutted against the radial outer portion of the end face on the one side in the axial direction of the connecting shaft portion 39a.

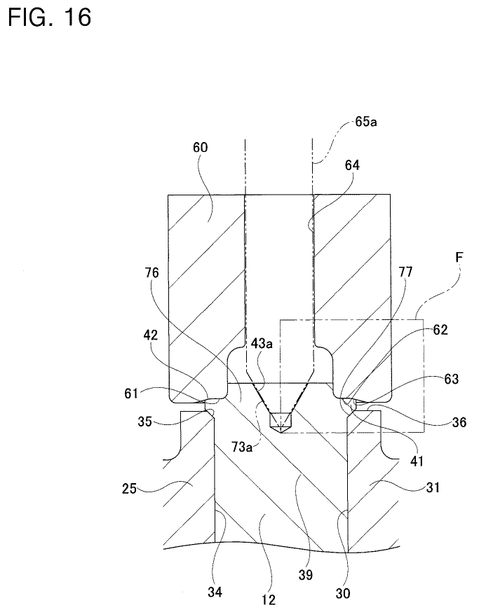

Next, the pressing punch 60 is moved further downward along the center shaft 65a from the state illustrated in FIG. 14 and FIG. 15 to the state illustrated in FIG. 16 and FIG. 17, whereby the flat surface portion 62 of the pressing surface 61 of the pressing punch 60 press the radial outer portion of the end edge portion on the one side in the axial direction of the connecting shaft portion 39a toward the other side in the axial direction. As a result, the radial outer portion is compressed in the axial direction to form the crimped portion 41.

More specifically, the radial outer portion is compressed in the axial direction, and the material of the radial outer portion is caused to flow toward the radial outer side along the flat surface portion 62 and the inclined surface portion 63 of the pressing surface 61 of the pressing punch 60, thereby forming the crimped portion 41. Then, the crimped portion 41 is brought into surface contact with the chamfered portion 35 of the joint member 25 over the entire circumference.

In particular, in the present example, when forming the crimped portion 41 in this manner, the inclined surface portion 63 of the pressing surface 61 of the pressing punch 60 presses the radial outer portion of the side surface on the one side in the axial direction of the crimped portion 41 toward the other side in the axial direction and toward the radial inner side. As a result, a compressive stress is applied to the crimped portion 41. The side surface on the one side in the axial direction of the crimped portion 41 becomes an inclined surface portion 42, which is a plastically processed surface, formed by pressing the inclined surface portion 63 of the pressing surface 61 thereto.

In the present example, when forming the crimped portion 41, only the radial outer portion of the end edge portion on the one side in the axial direction of the connecting shaft portion 39a is pressed and plastically deformed by the pressing surface 61 of the pressing punch 60, so deformation of the center hole 43a can be substantially prevented, unlike when the crimped portion is formed by expanding the entire end edge portion on the one side in the axial direction of the connecting shaft portion toward the radial outer side. Therefore, after forming the crimped portion 41, the center hole 43a can be effectively used when measuring bending and rotational runout of the shaft member 12 and when assembling the shaft member 12 with other members.

In this example, when forming the crimped portion 41, the radial outer portion of the side surface on the one side in the axial direction of the crimped portion 41 is pressed toward the other side in the axial direction and toward the radial inner side so as to apply a compressive stress to the crimped portion 41, so that cracks are difficult to occur in the crimped portion 41. However, in a case of implementing the present disclosure, when forming the crimped portion 41, the side surface on the one side in the axial direction of the crimped portion 41 may also be pressed toward the other side in the axial direction by a flat surface portion perpendicular to the axial direction.

Here, in a case of implementing the present disclosure, a structure may also be adopted in which the crimpled portion 41 contacts only plural locations separated in the circumferential direction of the opening perimeter edge portion 77 on the one side in the axial direction (for example, the chamfered portion 35) of the central hole 30 of the joint member 25. In this case, the load of processing the crimped portion can be suppressed, making manufacturing easier.

In a case of implementing the present disclosure, the press working of the crimped portion 41 can be performed in a plurality of steps. In this case, the processing load per step can be suppressed, making manufacturing easier.

### (3) Electric Power Steering Device

The electric power steering device 1 of the present example includes, as illustrated in FIG. 1, a steering wheel 2, a steering shaft 3, a steering column 4, a pair of universal joints 5a, 5b, an intermediate shaft 6, a steering gear unit 7, and an electric assist device 8 to which the shaft unit 56 of the present example is applied.

The steering wheel 2 is supported and fixed to a rear end portion of the steering shaft 3. The steering shaft 3 is rotatably supported inside the steering column 4 supported on the vehicle body. The front end portion of the steering shaft 3 is connected to a pinion shaft 9 of the steering gear unit 7 through the rear universal joint 5a, the intermediate shaft 6, and the front universal joint 5b.

Therefore, when the driver rotates the steering wheel 2, the rotation of the steering wheel 2 is transmitted to the pinion shaft 9 through the steering shaft 3, the pair of universal joints 5a, 5b, and the intermediate shaft 6. The rotation of the pinion shaft 9 is converted into linear motion of a rack shaft (not illustrated) of the steering gear unit 7 that engages with the pinion shaft 9. As a result, a pair of tie rods 10 are pushed and pulled, and a steering angle corresponding to the amount of rotation of the steering wheel 2 is applied to the left and right steered wheels. The electric assist device 8 is a device that generates auxiliary power to reduce the force required for the driver to operate the steering wheel 2.

### (4) Electric Assist Device

The electric assist device 8 of the present example includes, as illustrated in FIG. 2 and FIG. 3, a worm wheel 11, a worm 12, a coupling 13, and an electric motor 14. In the electric assist device 8, the shaft member 12 configuring the shaft unit 56 of the present example is applied as the worm 12.

The electric assist device 8 of the present example transmits the rotational torque of the output shaft 23 of the electric motor 14 to the worm 12 through the coupling 13, and then the rotational torque is amplified by a worm reducer configured by engaging the worm 12 with the worm wheel 11, and then applied to the steering shaft 3.

The electric assist device 8 of the present example further includes a housing 15 supported and fixed to the front end portion of the steering column 4. The housing 15 is a cast product of an iron-based alloy, a die-cast product of a light alloy such as aluminum, or an injection molded product of a synthetic resin, the housing 15 including a wheel accommodating portion 16 and a worm accommodating portion 17 that is arranged in a skewed position with respect to the wheel accommodating portion 16 and has an axial middle portion that opens to the wheel accommodating portion 16.

The wheel accommodating portion 16 is supported and fixed to the front end portion of the steering column 4 so that its central axis is coaxial with the central axis of the steering column 4.

The worm accommodating portion 17 is configured to be cylindrical, and has opening portions at both end portions in the axial direction. In the following description, regarding the worm accommodating portion 17 and the members accommodated in the worm accommodating portion 17, the one side in the axial direction is the right side in FIG. 2 and FIG. 3, and the other side in the axial direction is the left side in FIG. 2 and FIG. 3.

The opening portion on the one side in the axial direction of the worm accommodating portion 17 is closed by the electric motor 14 supported and fixed to the housing 15. The opening portion on the other side in the axial direction of the worm accommodating portion 17 is closed by a cover 18.

The worm wheel 11 has wheel teeth 19 on the outer circumferential surface, and is rotatably supported inside the wheel accommodating portion 16. In the present example, the worm wheel 11 is supported and fixed around the front end portion of the steering shaft 3, which is rotatably supported inside the wheel accommodating portion 16, so as to rotate integrally with the steering shaft 3. The worm wheel 11 of the present example is configured by connecting and fixing a synthetic resin gear portion 21, which has wheel teeth 19 on the outer circumferential surface thereof, around a circular disk-shaped core portion 20 which is made of metal.

The worm 12 is rotatably supported by a pair of ball bearings 46, 54 inside the worm accommodating portion 17. The end portion on the one side in the axial direction of the worm 12 is connected to a tip end portion of the output shaft 23 of the electric motor 14 through the coupling 13 so as to be able to transmit torque and pivot.

A biasing mechanism 55 including an elastic body such as a coil spring or a leaf spring is assembled between the outer circumferential surface of the ball bearing 54 supporting the end portion on the other side in the axial direction of the worm 12 and the inner circumferential surface of the worm accommodating portion 17. The biasing mechanism 55 elastically biases the worm teeth 22 of the worm 12 toward the wheel teeth 19 of the worm wheel 11. With this kind of construction, backlash that occurs between the worm teeth 22 and the wheel teeth 19 is suppressed, and the occurrence of chattering is suppressed.

The electric assist device 8 of the present example is arranged in a position where it applies auxiliary power to the steering shaft 3. However, the present disclosure may also be applied to an electric assist device arranged in a position where it applies auxiliary power to the pinion shaft or the rack shaft of the steering gear unit.

The coupling 13 includes a worm-side joint member 25, a motor-side joint member 24 that is connected and fixed to the tip end portion of the output shaft 23 of the electric motor 14, and an intermediate joint member 26 that connects the motor-side joint member 24 and the worm-side joint member 25 to enable torque transmission while allowing misalignment between them. The coupling 13 is entirely accommodated inside the worm accommodating portion 17. In the electric assist device 8 of the present example, the joint member 25 of the present example is applied to the worm-side joint member 25 of the coupling 13. Therefore, the shaft unit 56 of the present example is configured by the worm 12 and the worm-side joint member 25.

The motor-side joint member 24 is a member made of metal, and includes a cylindrical tubular portion 27 that is externally fitted and fixed to the tip end portion of the output shaft 23 of the electric motor 14, an annular flange portion 28 that protrudes toward the radial outer side from a middle portion in the axial direction of the tube portion 27, and tooth portions 29 that protrude toward the other side in the axial direction from plural locations (four locations in the present example) so as to be uniformly spaced in the circumferential direction on the radial outer portion of the flange portion 28. The end portion (tip end portion) on the other side in the axial direction of the tooth portions 29 is arranged on the other side in the axial direction of the tubular portion 27.

The intermediate joint member 26 is configured in an annular shape as a whole. The intermediate joint member 26 has insertion holes 38a at plural locations (four locations in the present example) so as to be uniformly spaced in the circumferential direction of a portion on the one side in the axial direction, into which the tooth portions 29 of the motor-side joint member 24 can be inserted, and has insertion holes 38b at plural locations (four locations in the present example) so as to be uniformly spaced in the circumferential direction of a portion on the other side in the axial direction, into which the tooth portions 33 of the worm-side joint member 25 can be inserted. In the present example, the intermediate joint member 26 is configured by combining an annular core material made of synthetic resin or metal material with a rubber cushioning material. Portions of the inner circumferential surfaces of the insertion holes 38a, 38b that come into contact with the tooth portions 29, 33 when torque is not being transmitted are made of cushioning material.

The tooth portions 29 of the motor-side joint member 24 are inserted into the plurality of insertion holes 38a of the intermediate joint member 26 from the one side in the axial direction, and the tooth portions 33 of the worm-side joint member 25 are inserted into the plurality of insertion holes 38b of the intermediate joint member 26 from the other side in the axial direction. As a result, the motor-side joint member 24 and the worm-side joint member 25 are connected through the intermediate joint member 26 to enable torque transmission while allowing mutual misalignment.

In the present example, the tip end portion of the output shaft 23 of the electric motor 14 and the end portion on the one side in the axial direction of the worm 12 are connected through the coupling 13 to enable torque transmission, thereby enabling the worm 12 to pivot relative to the output shaft 23.

In a case of implementing the present disclosure, the configuration of the coupling is not limited to the configuration of the present example. For example, as a coupling, a configuration may be adopted in which the motor-side joint member and the worm-side joint member are directly connected without using the intermediate joint member, while allowing mutual misalignment and enabling torque transmission.

In the present example, the fitting shaft portion 44 of the worm 12 is rotatably supported by a ball bearing 46 relative to the worm accommodating portion 17.

The ball bearing 46 includes an outer ring 47, an inner ring 48, and a plurality of balls 49.

The outer ring 47 is fitted into a cylindrical surface portion 50 provided on the inner circumferential surface of the end portion on the one side in the axial direction of the worm accommodating portion 17. In this state, the outer ring 47 is held from both sides in the axial direction by a stepped surface 51 facing the one side in the axial direction that exists in a portion adjacent to the other side in the axial direction of the cylindrical surface portion 50 of the worm accommodating portion 17, and a retaining ring 52 engaged with the cylindrical surface portion 50.

The inner ring 48 is fitted onto the fitting shaft portion 44 of the worm 12 with a clearance fit. Further, an O-ring 67 is engaged in a circumferential groove 66 formed on the outer circumferential surface of the middle portion in the axial direction of the fitting shaft portion 44, and the O-ring 67 is elastically held between the bottom surface of the circumferential groove 66 and the inner circumferential surface of the inner ring 48. That is, a minute radial gap exists between the inner circumferential surface of the inner ring 48 and the outer circumferential surface of the fitting shaft portion 44, and the worm 12 and the worm-side joint member 25 are supported by the O-ring 67 in a floating manner in the radial direction relative of the inner ring 48.

The worm 12 and the worm-side joint member 25 can be displaced in the radial direction relative to the inner ring 48 by the amount of the minute radial gap.

The inner ring 48 is arranged between a side surface on the other side in the axial direction of the tubular portion 31 of the worm-side joint member 25 and a stepped surface 68 facing the one side in the axial direction provided on the outer circumferential surface of the fitting shaft portion 44, with a minute axial gap in between. Further, the inner ring 48 is held from both sides in the axial direction by a side surface on the one side in the axial direction of the flange portion 45 of the worm 12 and a side surface on the other side in the axial direction of the flange portion 32 of the worm-side joint member 25 through a pair of worm dampers 53, each of which can be elastically compressed in the axial direction.

More specifically, the side surface on the other side in the axial direction of the inner ring 48 abuts against the side surface on the one side in the axial direction of the flange portion 45 through a worm damper 53 on the other axial side, and the side surface on the one side in the axial direction of the inner ring 48 abuts against the side surface on the other side in the axial direction of the flange portion 32 through a worm damper 53 on the one side in the axial direction.

That is, there are minute axial gaps between the side surface on the one side in the axial direction of the inner ring 48 and the side surface on the other side in the axial direction of the tubular portion 31 of the worm-side joint member 25, and between the side surface on the other side in the axial direction of the inner ring 48 and the stepped surface 68 of the worm 12, and the worm 12 and the worm-side joint member 25 are supported in a floating manner in the axial direction relative to the inner ring 48 by the pair of worm dampers 53. The worm 12 and the worm-side joint member 25 can be displaced to both sides in the axial direction by the amount of the minute axial gaps relative to the inner ring 48.

The plurality of balls 49 are arranged between an outer ring raceway provided on the inner circumferential surface of the outer ring 47 and an inner ring raceway provided on the outer circumferential surface of the inner ring 48.

The ball bearing 46 has radial gaps between the outer ring 47 and the balls 49 and between the inner ring 48 and the balls 49.

Therefore, the fitting shaft portion 44 of the worm 12 is supported in the worm accommodating portion 17 so as to be capable of pivotal displacement based on the presence of the minute radial gap, the minute axial gaps, and the radial gaps.

When the electric assist device 8 of the present example is in operation, an axial mesh reaction force acts on the worm 12 at the meshing area with the worm wheel 11. The direction of the axial mesh reaction force is reversed depending on the rotation direction of the worm 12.

The mesh reaction force that acts on the one side in the axial direction of the worm 12 is supported by the retaining ring 52 through the worm damper 53 on the other side in the axial direction and the ball bearing 46.

The mesh reaction force that acts on the other side in the axial direction of the worm 12 is supported by the stepped surface 51 of the worm accommodating portion 17 through the worm-side joint member 25, the worm damper 53 on the one side in the axial direction, and the ball bearing 46. In particular, when the mesh reaction force that acts on the other side in the axial direction of the worm 12 becomes large, the side surface on the one side in the axial direction of the inner ring 48 contacts the side surface on the other side in the axial direction of the tubular portion 31 of the worm-side joint member 25, and a large force directed toward the one side in the axial direction is applied from the inner ring 48 to the worm-side joint member 25.

Even in this case, in the present example, the crimped portion 41 provided on the connecting shaft portion 39 of the worm 12 is brought into surface contact over the entire circumference with the chamfered portion 35 that configures the opening perimeter edge portion on the one side in the axial direction of the central hole 30 of the worm-side joint member 25. As a result, the worm-side joint member 25 can be effectively prevented from falling off to the one side in the axial direction from the connecting shaft portion 39 by the crimped portion 41.

### Second Example

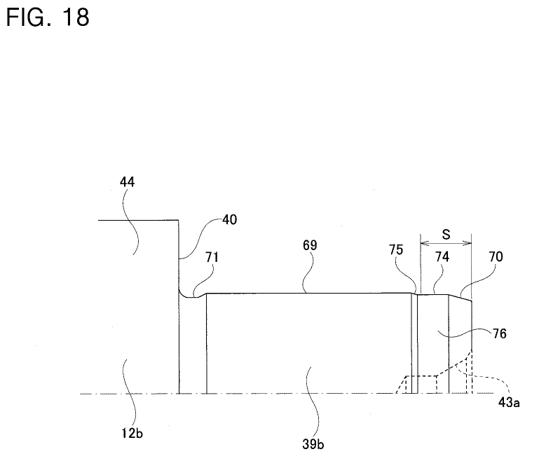

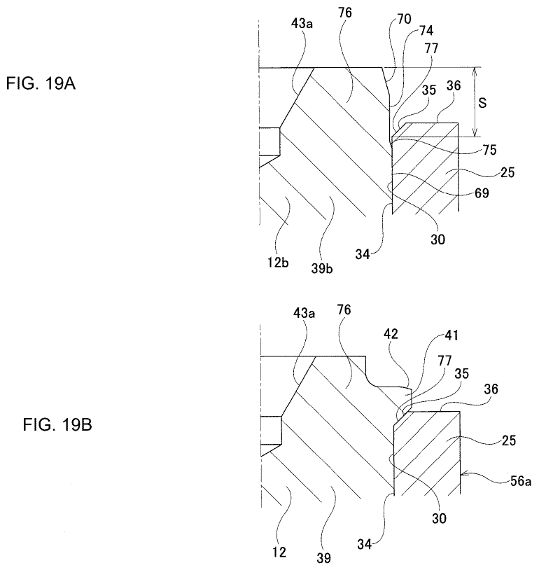

A second example of an embodiment of the present disclosure will be described with reference to FIG. 18 and FIG. 19.

In the present example, as in the first example, as illustrated in FIG. 19A, in a shaft unit 56a, the inner circumferential surface of the central hole 30 of the joint member 25 is configured with the serration portion 34. The teeth of the serration portion 34 (the tip portion of the teeth portion 33) are engaged into the outer circumferential surface of the connecting shaft portion 39 as the joint member 25 is press-fitted onto the outer circumferential surface of the connecting shaft portion 39 of the shaft member 12 from the one side in the axial direction.

In the method for manufacturing the shaft unit 56a of the present example, as illustrated in FIG. 18, in an intermediate shaft member 12b before the joint member 25 is press-fitted onto an outer circumferential surface of a connecting shaft portion 39b from the one side in the axial direction, the outer diameter of an entire portion of the connecting shaft portion 39b that protrudes from the radial inner side of the joint member 25 to the one side in the axial direction after the completion of the press-fitting of the joint member 25 (the portion illustrated as the axial range S in FIG. 18 and FIG. 19A) is set to be less than or equal to the inner diameter of the serration portion 34 provided on the inner circumferential surface of the central hole 30 of the joint member 25.

More specifically, in the present example, as illustrated in FIG. 18, the outer circumferential surface of the connecting shaft portion 39b of the intermediate shaft member 12b includes a small diameter portion 74 between a cylindrical surface portion 69 and a guide surface portion 70 with respect to the axial direction. The small diameter portion 74 is configured with a cylindrical surface whose outer diameter does not change with respect to the axial direction. An end portion on the one side in the axial direction of the small diameter portion 74 is directly connected to an end portion on the other side in the axial direction of the guide surface portion 70. An end portion on the other side in the axial direction of the small diameter portion 74 is connected to an end portion on the one side in the axial direction of the cylindrical surface portion 69 through a connecting portion 75 configured with a conical surface whose outer diameter increases toward the other side in the axial direction.

In the present example, as illustrated in FIG. 19A, when the process of press-fitting the joint member 25 is completed and the connecting shaft portion 39b is fitted into the central hole 30 of the joint member 25, only the end portion on the other side in the axial direction of the small diameter portion 74 is arranged on the radial inner side of the central hole 30 of the joint member 25. In other words, in a state where the press-fitting is completed, a portion excluding the end portion on the other side in the axial direction of the small diameter portion 74 and the guide surface portion 70 are arranged in a position protruding from the central hole 30 to the one side in the axial direction.

In the present example, the outer diameter of the small diameter portion 74 is less than or equal to the inner diameter of the serration portion 34. Accordingly, the outer diameter of the guide surface portion 70 is smaller than the inner diameter of the serration portion 34.

In the present example, by adopting arrangement and dimensional relationships as described above, at a stage prior to the step of press-fitting the joint member 25 onto the outer circumferential surface of the connecting shaft portion 39b from the one side in the axial direction, the outer diameter of the entire portion of the connecting shaft portion 39b that protrudes from the central hole 30 of the joint member 25 to the one side in the axial direction after the completion of the press-fitting (the portion illustrated as the axial range S in FIG. 18 and FIG. 19A), that is, the outer diameter of the portion of the small diameter portion 74 excluding the end portion on the other side in the axial direction, and the outer diameter of the entire guide surface portion 70 are set to be less than or equal to the inner diameter of the serration portion 34.

In the present example, the shape of the protruding portion (the portion illustrated as the axial range S in FIG. 18 and FIG. 19A) is a combination of the small diameter portion 74 configured with a cylindrical surface and the guide surface portion 70 configured with a conical surface. However, in a case of implementing the present disclosure, the protruding portion may have any shape as long as the outer diameter of the entire protruding portion is less than or equal to the inner diameter of the serration portion 34. For example, as the shape of the protruding portion, it is also possible to adopt a shape configured entirely with a cylindrical surface or a shape in which the outer diameter decreases gradually or stepwise as going toward the one side in the axial direction.

In the present example, as in the first example, as illustrated in FIG. 19A, in a state where the connecting shaft portion 39b is fitted into the central hole 30 of the joint member 25 by completing the press-fitting, as illustrated in FIG. 19A to FIG. 19B, press a radial outer portion of an end edge portion on the one side in an axial direction of the connecting shaft portion 39b protruding from the central hole 30 so as to compress the radial outer portion in the axial direction to form a crimped portion 41, and bringing the crimped portion 41 into surface contact with an opening perimeter edge portion 77 (chamfered portion 35) on the one side in the axial direction of the central hole 30 of the joint member 25.

In the manufacturing method of the present example, the outer diameter of the entire protruding portion (the portion illustrated as the axial range S in FIG. 18 and FIG. 19A) is less than or equal to the inner diameter of the serration portion 34. Therefore, compared to a structure in which the outer diameter of at least a portion of the protruding portion is larger than the inner diameter of the serration portion 34 (for example, the structure of the first example), the amount of axial press-fit stroke when performing the press-fitting process can be kept small. Therefore, the energy required for performing the press-fitting can be reduced accordingly.

Further, the distance in the radial direction between the outer circumferential surface of the protruding portion and the opening perimeter edge portion (in the present example, the chamfered portion 35) on the one side in the axial direction of the central hole 30 can be more widely secured. Therefore, when forming the crimped portion 41 by compressing the radial outer portion of the protruding portion in the axial direction, the material that is compressed can be made to flow more easily toward the outer diameter side, thereby improving the formability of the crimped portion 41.

Furthermore, formation of passing marks (scraping marks) in the axial direction of the teeth of the serration portion 34 at plural locations in the circumferential direction on the outer circumferential surface of the protruding portion can be more effectively prevented. That is, in the present example, even if the passing marks in the axial direction of the teeth of the serration portion 34 are formed at plural locations in the circumferential direction on the outer circumferential surface of the connecting shaft portion 39b, and only if scraped pieces (burrs) are formed at edges of the passing marks, the passing marks and scraped pieces do not exist on a portion protruding from the central hole 30 of the joint member 25 to the one side in the axial direction. An opening portion on the one side in the axial direction on the inside of the central hole 30, that is, the opening portion on the one side in the axial direction of the grooves of the serration portion 34, is closed by the crimped portion 41. As a result, the scraped pieces are effectively prevented from falling off to the periphery.

In a structure in which the entire connecting shaft portion 39 is larger than the inner diameter of the serration portion 34, when the passing marks in the axial direction of the teeth of the serration portion 34 are formed at plural locations in the circumferential direction on the outer circumferential surface of the protruding portion and the scraped pieces are formed at the edges of the passing marks, by performing a process of removing the scraped pieces after forming the crimped portion 41 and before accommodating the completed shaft unit 56 in the housing 15 of the worm reducer, it is possible to prevent the scraped pieces from falling off inside the housing 15. In the present example, it is possible to omit the process of removing such scraped pieces. Other configuration and operational effects are the same as those of the first example.

### REFERENCE SIGNS LIST

1 Electric power steering device
2 Steering wheel
3 Steering shaft
4 Steering column
5a, 5b Universal joint
6 Intermediate shaft
7 Steering gear unit
8 Electric assist device
9 Pinion shaft
10 Tie rod
11 Worm wheel
12 Shaft member (worm)
12a, 12b Intermediate shaft member
13 Coupling
14 Electric motor
15 Housing
16 Wheel accommodating portion
17 Worm accommodating portion
18 Cover
19 Wheel teeth
20 Core portion
21 Gear portion
22 Worm teeth
23 Output shaft
24 Motor-side joint member
25 Joint member (worm-side joint member)
26 Intermediate joint member
27 Tubular portion
28 Flange portion
29 Tooth portion
30 Central hole
31 Tubular portion
32 Flange portion
33 Tooth portion
34 Serration portion
35 Chamfered portion
36 End surface
37 Large diameter portion
38a, 38b Insertion holes
39, 39a, 39b Connecting shaft portion
40 Stepped surface
41 Crimped portion
42 Inclined surface portion
43a, 43b Center hole
44 Fitting shaft portion
45 Flange portion
46 Ball bearing
47 Outer ring
48 Inner ring
49 Ball
50 Cylindrical surface portion
51 Stepped surface
52 Retaining ring
53 Worm damper
54 Ball bearing
55 Biasing mechanism
56 Shaft unit
57 Support base
58 Support hole
59 Support surface
60 Pressing punch
61 Pressing surface
62 Flat surface portion
63 Inclined surface portion
64 Guide hole portion
65, 65a Center shaft
66 Circumferential groove
67 O-ring
68 Stepped surface
69 Cylindrical surface portion
70 Guide surface portion
71 Relief groove
72 Press-fitting jig
73, 73a Engaging portion
74 Small diameter portion
75 Connecting portion
76 Cylindrical portion
77 Opening perimeter edge portion
78 Opening perimeter edge portion

1. A shaft unit, comprising:
a shaft member having a connecting shaft portion at an end portion on one side in an axial direction and a center hole opening to a center portion in a radial direction of an end surface on the one side in the axial direction of the connecting shaft portion, and
a joint member having a central hole penetrating in the axial direction on a radial inner side, with the connecting shaft portion fitted into the central hole,
the connecting shaft portion having a crimped portion formed by plastically deforming only a radial outer portion of an end edge portion on the one side in the axial direction protruding from the central hole, and
the crimped portion brought into surface contact with an opening perimeter edge portion on the one side in the axial direction of the central hole of the joint member.

2. The shaft unit according to claim 1, wherein at least a radial outer portion of a side surface on the one side in the axial direction of the crimped portion is configured with an inclined surface portion that is inclined in a direction toward the other side in the axial direction as going toward a radial outer side.

3-9. (canceled)

10. The shaft unit according to claim 2, wherein the inclined surface portion is a plastically processed surface.

11. The shaft unit according to claim 2, wherein
a generatrix shape of the inclined surface portion is a straight line, and
an inclination angle of the inclined surface portion with respect to an imaginary flat plane perpendicular to the axial direction of the shaft member is set to 15 degrees or more and 45 degrees or less.

12. The shaft unit according to claim 1, wherein the opening perimeter edge portion of the joint member is configured with a chamfered portion that is inclined in a direction toward a radial outer side as going toward the one side in the axial direction.

13. The shaft unit according to claim 1, wherein
an inner circumferential surface of the central hole is configured with a serration portion, and
teeth of the serration portion are engaged into an outer circumferential surface of the connecting shaft portion.

14. The shaft unit according to claim 13, wherein
a large diameter portion having an inner diameter larger than the inner circumferential surface of the central hole is provided at an opening perimeter edge portion on the other side in the axial direction of the central hole of the joint member, and
a space exists between the outer circumferential surface of the connecting shaft portion and the large diameter portion of the joint member.

15. The shaft unit according to claim 13, wherein an opening portion on the one side in the axial direction of grooves of the serration portion is entirely blocked by the crimped portion.

16. The shaft unit according to claim 1, wherein a relief groove is provided over an entire circumference at an end portion on the other side in the axial direction of the outer circumferential surface of the connecting shaft portion, which is located further on the other side in the axial direction than a portion that is fitted into the central hole of the joint member.

17. The shaft unit according to claim 1, wherein the center hole is located at an end portion on the one side in the axial direction of the connecting shaft portion and is arranged so as to overlap with the crimped portion in the radial direction, and a portion around the center hole at the end portion on the one side in the axial direction of the connecting shaft portion is configured with a cylindrical portion.

18. The shaft unit according to claim 1, wherein the shaft member is configured as a worm.

19. The shaft unit according to claim 18, wherein
the shaft member includes, in a portion between the connecting shaft portion and worm teeth of the worm, in order from the one side in the axial direction, a fitting shaft portion having a diameter larger than the connecting shaft portion, and a flange portion protruding radially outward,
an outer circumferential surface of the connecting shaft portion and an outer circumferential surface of the fitting shaft portion are connected by a stepped surface facing the one side in the axial direction, and
the joint member is held from both sides in the axial direction by the stepped surface and the crimped portion of the shaft member.

20. An electric assist device, comprising:
a worm wheel,
a worm engaged with the worm wheel,
a coupling including a joint member connected to a connecting shaft portion provided at an end portion on one side in an axial direction of the worm, and
an electric motor that transmits torque to the worm through the coupling, wherein a shaft unit including the worm and the joint member is configured with the shaft unit according to claim 11.

21. A method for manufacturing a shaft unit,
the shaft unit comprises:
a shaft member having a connecting shaft portion at an end portion on one side in an axial direction and a center hole opening to a center portion in a radial direction of an end surface on the one side in the axial direction of the connecting shaft portion, and a joint member having a central hole penetrating in the axial direction on a radial inner side,
the method comprises a step of:
pressing a radial outer portion of an end edge portion on the one side in the axial direction of the connecting shaft portion protruding from the central hole in a state where the connecting shaft portion is fitted into the central hole of the joint member so as to compress the radial outer portion in the axial direction to form a crimped portion, and bringing the crimped portion into surface contact with an opening perimeter edge portion on the one side in the axial direction of the central hole of the joint member.

22. The method for manufacturing a shaft unit according to claim 21, wherein, in the process of forming the crimped portion using the pressing punch, a conical engaging portion provided at a lower end portion of a center shaft, which is inserted into a guide hole portion of the pressing punch with no looseness in the radial direction, is engaged with the center hole.

23. The method for manufacturing the saft unit according to claim 21 comprises:
a step of press-fitting the joint member onto an outer circumferential surface of the connecting shaft portion from the one side in the axial direction, wherein
in the shaft unit,
an inner circumferential surface of the central hole is configured with a serration portion,
an outer diameter of an entire portion of the connecting shaft portion that protrudes from the central hole of the joint member to the one side in the axial direction is less than or equal to an inner diameter of the serration portion, and
in the step of press-fitting the joint member, teeth of the serration portion are engaged into the outer circumferential surface of the connecting shaft portion, and by completing the press-fitting of the joint member, the connecting shaft portion is fitted into the central hole of the joint member.

24. The method for manufacturing the shaft unit according to claim 21,
the method comprises a step of:
press-fitting the joint member onto the outer circumferential surface of the connecting shaft portion of an intermediate shaft member from the one side in the axial direction using a cylindrical press-fitting jig,
wherein a columnar center shaft is inserted with no looseness in the radial direction into the joint member and the press-fitting jig arranged adjacent to and above the joint member, and then a conical engaging portion provided in a center portion in the radial direction of a lower end portion of the center shaft is engaged with the center hole.

25. The method for manufacturing the shaft unit according to claim 21, wherein in the process of forming the crimped portion, a radial outer portion of the pressing surface presses a side surface on the one side in the axial direction of the crimped portion toward the other side in the axial direction and toward the radial inner side.

26. The method for manufacturing the shaft unit according to claim 21, wherein the shaft member is configured as a worm.
